(19) United States
(12) Patent Application Publication
(10) Pub. No.: US 2025/0025779 A1
(43) Pub. Date: Jan. 23, 2025

(54) SYSTEM, INFORMATION PROCESSING APPARATUS, INFORMATION PROCESSING METHOD, AND NON-TRANSITORY COMPUTER-READABLE STORAGE MEDIUM

(71) Applicant: NINTENDO CO., LTD., Kyoto (JP)

(72) Inventors: Kochi KAWAI, Kyoto (JP); Shoji MASUBUCHI, Kyoto (JP)

(21) Appl. No.: 18/909,668

(22) Filed: Oct. 8, 2024

Related U.S. Application Data
(63) Continuation of application No. PCT/JP2022/017515, filed on Apr. 11, 2022.

(51) Int. Cl. A63F 13/42; A63F 13/214; G06F 3/044; G06F 3/04812

(52) U.S. Cl. CPC A63F 13/42; A63F 13/214; G06F 3/044; G06F 3/04812

(57) ABSTRACT

A system includes a controller operated by a user and one or more processors. The controller includes a plurality of pressable buttons that are independent of each other, a first sensor that detects pressing of at least one of the buttons, and a second sensor that detects approach or contact of a finger of a user to at least one of the plurality of buttons. When a movement operation to sequentially approach or contact at least two buttons with the finger of the user is performed, the one or more processors perform first processing based on an order of the buttons approached or contacted in the movement operation.

This nonprovisional application claims priority on and is a continuation of International Patent Application PCT/JP2022/017515 filed with the Japan Patent Office on Apr. 11, 2022, the entire contents of which are hereby incorporated by reference.

### FIELD

The present disclosure relates to a system, an information processing apparatus, an information processing method, and a program.

### BACKGROUND AND SUMMARY

In order to improve user friendliness, a touch pad capable of detecting a touch operation has been adopted in various products.

For example, an imaging apparatus including a circular touch pad and an enter button of a pressing type provided in a central portion of the touch pad has been known. The imaging apparatus controls display of a menu screen in accordance with a result of sensing of a direction of rotation and a speed of rotation of a finger on the touch pad.

In the background art, when viewed from a user side, it is difficult to know whether or not input of a touch operation has been received on the touch pad, and when viewed from an apparatus side, it may be difficult to determine an intention of the touch operation by the user. In addition, since the touch pad and the enter button are each provided, a space for arrangement is required.

The present disclosure provides a controller improved in usability and processing in accordance with an operation performed onto the controller.

(Configuration 1) An exemplary embodiment provides a system that includes a controller to be operated by a user and one or more processors. The controller includes a plurality of pressable buttons that are independent of other, a first sensor that detects pressing of at least one of the buttons, and a second sensor that detects approach or contact of a finger of a user to at least one of the plurality of buttons. When a movement operation to sequentially approach or contact at least two buttons with the finger of the user is performed, the one or more processors perform first processing based on an order of the buttons approached or contacted in the movement operation.

According to Configuration 1, approach or contact of the finger of the user to at least one of the plurality of buttons can be detected. Therefore, the system can obtain not only information on an operation by the user to press a button but also information on an operation by the user such as approach or contact to at least one of the buttons. In addition, since the plurality of pressable buttons that are independent of each other are adopted, the user can indicate a function allocated to pressing of each button and can distinguish between buttons based on a tactile impression at a fingertip and then give the system an intended instruction based on approach or contact to a target button. The controller improved in usability and processing in accordance with an operation given to the controller can thus be achieved.

(Configuration 2) In Configuration 1, the one or more processors may perform second processing based on pressing of a button of the plurality of buttons after the first processing is performed.

According to Configuration 2, since the second processing is performed in response to pressing of any button by the user after the first processing is performed, the user can perform an intuitive operation.

(Configuration 3) In Configuration 2, the one or more processors may perform the second processing whichever button of the plurality of buttons may be pressed.

For example, an example where a specific button among the plurality of buttons has to be pressed in order to perform the second processing is assumed. Then, depending on aspects of an immediately preceding movement operation, a finger should further be moved for pressing the specific button and this additional movement may erroneously be determined as a part of the immediately preceding movement operation. According to Configuration 3, in contrast, whichever button of the plurality of buttons may be pressed, by performing the second processing, possibility that processing unintended by the user is performed can be lowered.

(Configuration 4) In Configuration 2 or 3, the one or more processors may perform the second processing based on pressing of a button last in the movement operation while the finger of the user has approached or contacted the button.

According to Configuration 4, the second processing is not performed unless the button last in the movement operation is pressed while the finger of the user has approached or contacted the button. Therefore, possibility that the second processing is erroneously performed when the user finishes the movement operation and attempts to perform another operation can be lowered.

(Configuration 5) In Configuration 2 or 3, the one or more processors may perform the second processing based on pressing of a button last approached or contacted in the movement operation before lapse of a predetermined time period since the finger of the user moved away from the button.

According to Configuration 5, the second processing is not performed unless the button last approached or contacted in the movement operation is pressed before lapse of the predetermined time period since the finger of the user moved away from the button. Therefore, possibility that the second processing is erroneously performed when the user finishes the movement operation and attempts to perform another operation can be lowered.

(Configuration 6) In any one of Configurations 1 to 5, the plurality of buttons may include at least three buttons. The movement operation may include the finger of the user sequentially approaching or contacting the at least three buttons.

According to Configuration 6, since the first processing is performed by sequential approach or contact of the finger of the user to the at least three buttons, possibility that the first processing unintended by the user is performed even when the user erroneously approaches or contacts two buttons can be lowered.

(Configuration 7) In any one of Configurations 1 to 6, the one or more processors may make processing aspects of the first processing different depending on whether the order of buttons approached or contacted in the movement operation is a clockwise order or a counterclockwise order.

According to Configuration 7, since the user can make selection between two kinds of processing simply by switching the order of buttons to be approached or contacted by the finger of the user himself/herself between the clockwise order and the counterclockwise order, usability can be improved.

(Configuration 8) In any one of Configurations 1 to 6, the first processing may include processing for moving a cursor for selection of at least one of a plurality of shown items.

According to Configuration 8, the cursor can more intuitively be moved by such a movement operation as sequential approach or contact of the finger of the user to at least two buttons. In addition, according to Configuration 8, since the operation can be performed while presence of the button is felt owing to the tactile impression at the fingertip, operation aspects given by the user to the system are understood more readily than in an example where a flat touch panel is operated.

(Configuration 9) In Configuration 1, the one or more processors may perform the first processing based on pressing subsequent to the movement operation, of at least one of the plurality of buttons or a button different from the plurality of buttons.

According to Configuration 9, since the first processing is not performed unless a button is pressed, possibility that the first processing unintended by the user is performed can be lowered.

(Configuration 10) In Configuration 9, the one or more processors may perform the first processing based on pressing subsequent to the movement operation, of a button last approached or contacted in the movement operation.

According to Configuration 10, the button last approached or contacted in the movement operation should only be pressed. Therefore, when the user intends to perform the first processing, the first processing can more readily be performed.

(Configuration 11) In Configuration 9 or 10, the one or more processors may perform the first processing based on pressing of a button last in the movement operation while the finger of the user has approached or contacted the button.

According to Configuration 11, the first processing is not performed unless the button last in the movement operation is pressed while the finger of the user has approached or contacted the button. Therefore, possibility that the first processing unintended by the user is performed can be lowered.

(Configuration 12) In Configuration 9 or 10, the one or more processors may perform the first processing based on pressing of a button last approached or contacted in the movement operation before lapse of a predetermined time period since the finger of the user moved away from the button.

According to Configuration 12, the first processing is not performed unless the button last approached or contacted in the movement operation is pressed before lapse of the predetermined time period since the finger of the user moved away from the button. Therefore, possibility that the first processing unintended by the user is performed can be lowered.

(Configuration 13) In any one of Configurations 1 to 12, the one or more processors do not have to perform processing in accordance with an operation by the user simply in response to approach or contact of the finger of the user alone to one of the buttons.

According to Configuration 13, possibility that unintended processing is performed due to approach or contact to any one button unintended by the user can be lowered.

(Configuration 14) In Configuration 13, the controller may be configured to be held by the user. The plurality of buttons may be provided in a first area where the plurality of buttons are operable with one finger of the user who holds the controller.

According to Configuration 14, since the plurality of buttons can be operated with a single finger of the user who holds the controller, user friendliness can be improved.

(Configuration 15) In Configuration 14, a plurality of pressable buttons that are independent of each other may be provided in a second area different from the first area. The plurality of buttons provided in the first area and the plurality of buttons provided in the second area may be configured to independently detect the movement operation onto the plurality of buttons.

According to Configuration 15, since the plurality of buttons provided in the first area and the plurality of buttons provided in the second area can be operated, user friendliness can be improved.

(Configuration 16) In any one of Configurations 1 to 15, the plurality of buttons may include four buttons. The four buttons may annularly be arranged.

According to Configuration 16, since the buttons are annularly arranged, the user can more readily perform such an operation as cyclically moving the finger along the buttons.

(Configuration 17) In Configuration 16, when the movement operation is such that the finger of the user moves from a first button among the four buttons to approach or contact a second button different from a third button and a fourth button adjacent to the first button, the one or more processors may perform the first processing based on approach or contact of the finger of the user to the third button and the fourth button among the four buttons.

According to Configuration 17, in the movement operation from one button to another button which is not adjacent thereto, a resolution of detection can be enhanced by using information on approach or contact to a button adjacent to a button from which movement originates.

(Configuration 18) In Configuration 17, the one or more processors may perform the first processing based on approach or contact of the finger of the user to both of the third button and the fourth button.

According to Configuration 18, since the first processing is performed on condition that the finger of the user approaches or contacts both of the third button and the fourth button, intention of the user can more reliably be reflected.

(Configuration 19) In Configuration 17, the one or more processors may perform identical first processing in both of a case where the finger of the user approaches or contacts one of the third button and the fourth button and a case where the finger of the user approaches or contacts both of the third button and the fourth button.

According to Configuration 19, since identical first processing is performed even when one button is not approached or contacted for some reason, possibility of awkwardness felt by the user can be lowered.

(Configuration 20) In any one of Configurations 1 to 19, the one or more processors may perform processing and output an image generated by the performed processing. The first processing may include processing for changing an outputted image.

According to Configuration 20, in response to the operation onto the controller by the user, a result of the operation is visually provided and hence usability can be improved.

(Configuration 21) Another exemplary embodiment provides an information processing apparatus connected to a controller to be operated by a user. The controller includes a plurality of pressable buttons that are independent of each other, a first sensor that detects pressing of at least one of the buttons, and a second sensor that detects approach or contact of a finger of a user to at least one of the plurality of buttons. The information processing apparatus includes one or more processors. When such a movement operation that the finger of the user sequentially approaches or contacts at least two buttons is performed, the one or more processors perform first processing based on an order of the buttons approached or contacted in the movement operation.

(Configuration 22) Another exemplary embodiment provides an information processing method performed in a system including a controller to be operated by a user. The controller includes a plurality of pressable buttons that are independent of each other, a first sensor that detects pressing of at least one of the buttons, and a second sensor that detects approach or contact of a finger of a user to at least one of the plurality of buttons. The information processing method includes accepting an operation by the user onto the controller and performing, when such a movement operation that the finger of the user sequentially approaches or contacts at least two buttons is performed, first processing based on an order of the buttons approached or contacted in the movement operation.

(Configuration 23) Another exemplary embodiment provides a program executed in a computer connected to a controller to be operated by a user. The controller includes a plurality of pressable buttons that are independent of each other, a first sensor that detects pressing of at least one of the buttons, and a second sensor that detects approach or contact of a finger of a user to at least one of the plurality of buttons. The program causes the computer to perform operations including accepting an operation by the user onto the controller and performing, when such a movement operation that the finger of the user sequentially approaches or contacts at least two buttons is performed, first processing based on an order of the buttons approached or contacted in the movement operation.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary overall configuration of a system according to the present embodiment.

FIG. 2 shows an exemplary illustrative non-limiting drawing illustrating an exemplary form of use while a controller is attached to a main body apparatus in the system according to the present embodiment.

FIG. 3 shows an exemplary illustrative non-limiting drawing illustrating an exemplary form of use while the controller has been removed from the main body apparatus in the system according to the present embodiment.

FIG. 4 shows an exemplary illustrative non-limiting drawing illustrating an exemplary hardware configuration of the main body apparatus of the system according to the present embodiment.

FIG. 5 shows an exemplary illustrative non-limiting drawing illustrating an exemplary cross-sectional structure of a button of the controller in the system according to the present embodiment.

FIG. 6 shows an exemplary illustrative non-limiting drawing illustrating an exemplary hardware configuration of the controller of the system according to the present embodiment.

FIG. 7 shows an exemplary illustrative non-limiting drawing illustrating exemplary cursor movement processing in the system according to the present embodiment.

FIG. 8 shows an exemplary illustrative non-limiting drawing illustrating an exemplary operation by a user corresponding to the cursor movement processing shown in FIG. 7.

FIG. 9 shows an exemplary illustrative non-limiting drawing illustrating another exemplary operation by the user corresponding to the cursor movement processing in the system according to the present embodiment.

FIG. 10 shows an exemplary illustrative non-limiting drawing illustrating an exemplary operation by the user to cancel cursor movement input stand-by or a cursor movement mode in the system according to the present embodiment.

FIG. 11 shows an exemplary illustrative non-limiting drawing illustrating a flowchart showing a processing procedure in the cursor movement processing in the system according to the present embodiment.

FIG. 12 shows an exemplary illustrative non-limiting drawing illustrating an exemplary operation by the user for transition to a state of cursor movement input stand-by in the system according to the present embodiment.

FIG. 13 shows an exemplary illustrative non-limiting drawing illustrating exemplary allocation of a function in the cursor movement mode in the system according to the present embodiment.

FIG. 14 shows an exemplary illustrative non-limiting drawing illustrating an exemplary operation by the user corresponding to the cursor movement processing in using two controllers in the system according to the present embodiment.

FIG. 15 shows an exemplary illustrative non-limiting drawing illustrating another exemplary cursor movement processing in the system according to the present embodiment.

FIG. 16 shows an exemplary illustrative non-limiting drawing illustrating exemplary game processing in the system according to the present embodiment.

FIG. 17 shows an exemplary illustrative non-limiting drawing illustrating an exemplary operation by the user corresponding to exemplary game processing in the system according to the present embodiment.

FIG. 18 shows an exemplary illustrative non-limiting drawing illustrating an exemplary operation by the user corresponding to game processing in using two controllers in the system according to the present embodiment.

FIG. 19 shows an exemplary illustrative non-limiting drawing illustrating yet another exemplary game processing in the system according to the present embodiment.

FIG. 20 shows an exemplary illustrative non-limiting drawing illustrating exemplary character input processing in the system according to the present embodiment.

FIG. 21 shows an exemplary illustrative non-limiting drawing illustrating an exemplary operation guide function in the system according to the present embodiment.

FIG. 22 shows an exemplary illustrative non-limiting drawing illustrating exemplary combination between an operation onto the controller and a touch operation in the system according to the present embodiment.

FIG. 23 shows an exemplary illustrative non-limiting drawing illustrating exemplary combination between an operation onto a direction indicator of the controller and a touch operation in the system according to the present embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### A. Exemplary Overall Configuration

An exemplary overall configuration of a system according to the present embodiment will initially be described. Though a system that performs game processing will mainly be described in the description below, the system according to the present embodiment and processing which will be described later are applicable to various applications other than the game processing.

The system according to the present embodiment may be configured with any electronic devices such as a smartphone, a tablet, and a personal computer.

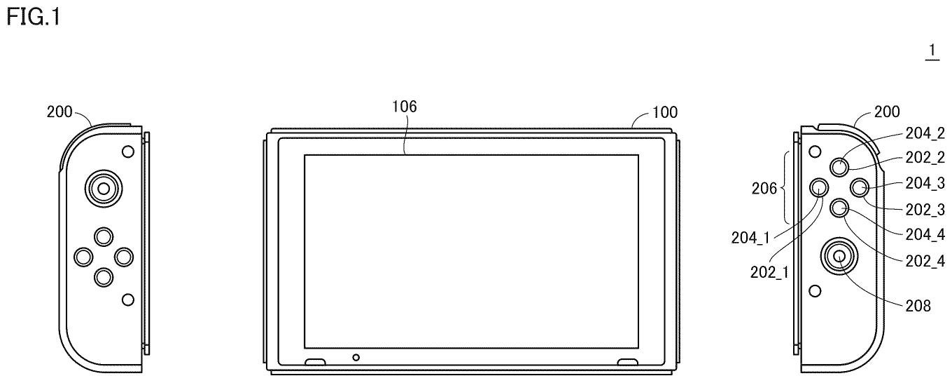

An exemplary overall configuration of a system 1 according to the present embodiment will be described with reference to FIG. 1. System 1 includes a main body apparatus 100 representing an exemplary information processing apparatus and one or more controllers 200 to be operated by a user.

Main body apparatus 100 proceeds with an application such as a game in accordance with data indicating an operation by the user from each of controllers 200.

Each of controllers 200 accepts the operation by the user. More specifically, controller 200 includes a button operation portion 206 composed of a plurality of pressable buttons that are independent of each other and a direction indicator 208. Button operation portion 206 and direction indicator 208 are provided in an area where they are operable with a single finger of the user who holds controller 200.

For example, button operation portion 206 includes four buttons 202_1 to 202_4 (which may also collectively be referred to as a “button 202” below). On respective upper surfaces (exposed surfaces) of buttons 202_1 to 202_4 where the operation by the user is accepted, touch sensors 204_1 to 204_4 (which may also collectively be referred to as a “touch sensor 204” below) capable of detecting approach or contact of a finger of the user to buttons 202_1 to 202_4 are provided. By adoption of such an arrangement, button operation portion 206 can not only detect pressing of any button 202 by the user but also detect approach or contact of the finger of the user to any button 202.

Approach or contact of the finger of the user (or a part of the body of the user) to any button 202 will herein be referred to as “touch”. Closeness of the finger of the user to button 202 which is the basis for determination as “touch” by system 1 can freely be designed.

Direction indicator 208 accepts an instruction for a direction (for example, one of four directions or an angle) from the user. For example, direction indicator 208 can include a slide stick which indicates a direction by tilt of a protrusion by the user, an analog stick which indicates a direction by slide of a protrusion by the user, a cross-shaped button, and a set of buttons arranged in four respective directions.

A specific example of processing in accordance with the operation by the user onto controller 200 will be described later.

Controller 200 may be attachable to main body apparatus 100. While controller 200 is distant from main body apparatus 100, main body apparatus 100 and controller 200 transmit and receive data therebetween through wireless communication. While controller 200 is attached to main body apparatus 100, main body apparatus 100 and controller 200 transmit and receive data therebetween through wired communication and/or wireless communication.

Controller 200 can be held by the user, solely or in a state that it is attached to main body apparatus 100.

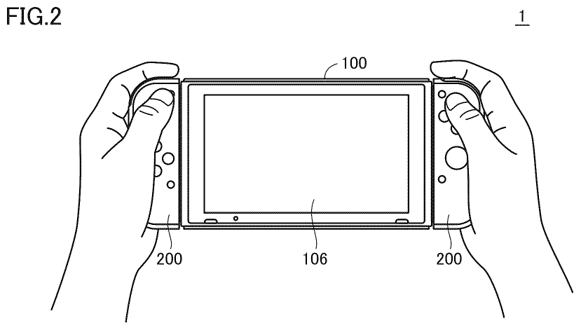

An example in which controller 200 is used as being attached to main body apparatus 100 in system 1 according to the present embodiment will be described with reference to FIG. 2. The user can use main body apparatus 100 by holding main body apparatus 100 to which a pair of controllers 200 is attached.

As shown in FIG. 2, when two controllers 200 are used as being attached to main body apparatus 100, button operation portion 206 and direction indicator 208 are provided in an area where they are operable with a single finger of the user who holds one controller 200, and another button operation portion 206 and another direction indicator 208 are provided in another area where they are operable with a single finger of the user who holds the other controller 200. In this arrangement, button operation portion 206 (composed of a plurality of buttons 202) provided in one controller 200 and another button operation portion 206 (composed of a plurality of buttons 202) provided in the other controller 200 can independently detect touch by the user to the plurality of buttons 202.

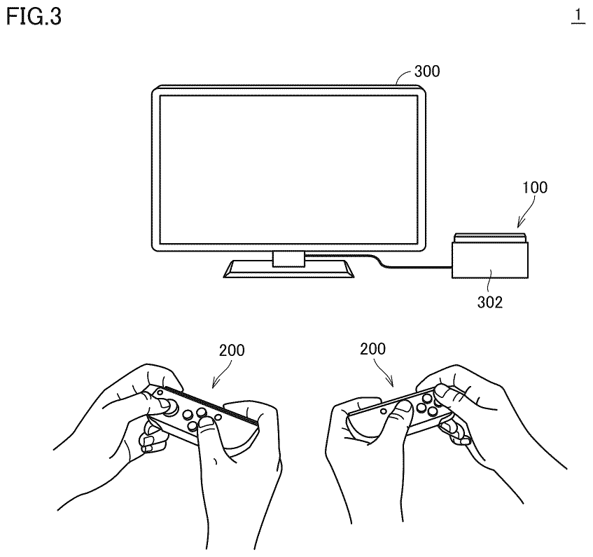

An example where controller 200 is used as having been removed from main body apparatus 100 in system 1 according to the present embodiment will be described with reference to FIG. 3. In a state where main body apparatus 100 is carried on a dock 302, one or more users operate controller(s) 200 while viewing an image outputted to an external display 300.

In another example where controller 200 is used as having been removed from main body apparatus 100, in a state where main body apparatus 100 is placed such that the user can visually recognize a display 106, one or more users may operate controller(s) 200 while viewing an image outputted to display 106.

In any exemplary use shown in FIGS. 2 and 3, four buttons 202_1 to 202_4 included in button operation portion 206 of controller 200 are annularly arranged. According to such arrangement, the user can perform a cyclic touch operation along any direction onto buttons 202_1 to 202_4. For example, the user can thus more readily perform such an operation as successively touching the buttons clockwise and/or counterclockwise.

Though FIG. 1 shows an exemplary arrangement in which buttons 202 are arranged above, below, on the left, and on the right by way of example, buttons 202 may be arranged in any manner so long as the user can perform the cyclic touch operation.

### B. Exemplary Hardware Configuration of System 1

An exemplary hardware configuration of system 1 according to the present embodiment will now be described.

### (b1: Main Body Apparatus 100)

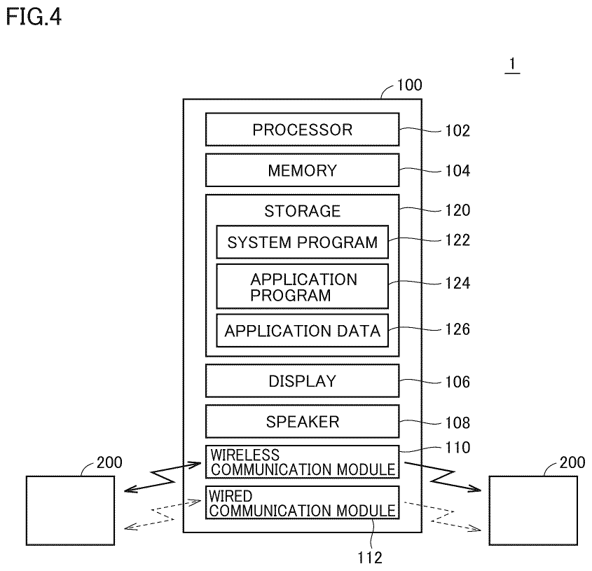

An exemplary hardware configuration of main body apparatus 100 of system 1 according to the present embodiment will be described with reference to FIG. 4. Main body apparatus 100 includes one or more processors 102, a memory 104, a storage 120, display 106, a speaker 108, a wireless communication module 110, and a wired communication module 112.

Processor 102 is a processing entity for performing processing provided by main body apparatus 100. Processor 102 performs various types of processing and outputs an image generated by the performed processing. Memory 104 is a storage device that can be accessed by processor 102, and it is implemented, for example, by a volatile storage device such as a dynamic random access memory (DRAM) or a static random access memory (SRAM). Storage 120 is implemented, for example, by a non-volatile storage device such as a flash memory.

Processor 102 performs processing as will be described later by reading a program stored in storage 120, developing the program on memory 104, and executing the program. For example, a system program 122 that provides a library necessary for execution of a program, an application program 124 composed of computer readable instruction codes for implementing any information processing, and application data 126 referred to at the time of execution of application program 124 are stored in storage 120.

The term “processor” herein encompasses processing circuitry that performs processing in accordance with an instruction code described in a program, such as a central processing unit (CPU), a micro processing unit (MPU), or a graphics processing unit (GPU) and hard-wired circuitry such as an application specific integrated circuit (ASIC) or a field programmable gate array (FPGA). In the hard-wired circuitry such as an ASIC or an FPGA, a circuit corresponding to processing to be executed is formed in advance. Furthermore, the “processor” herein also encompasses circuitry in which a plurality of functions are integrated, such as a system on chip (SoC) and combination of the processor in a narrow sense and the hard-wired circuitry. Therefore, the “processor” herein can also be referred to as the processing circuitry.

Display 106 shows an image based on a result of processing by processor 102. Speaker 108 generates any sound around main body apparatus 100.

Wireless communication module 110 transmits and receives a wireless signal to and from any apparatus. For example, in transmission and reception of a wireless signal to and from one or more controllers 200 operated by the user, any wireless scheme such as Bluetooth®, ZigBee®, wireless LAN (IEEE 802.11), or infrared communication can be adopted for wireless communication module 110.

Wired communication module 112 transmits and receives a wired signal to and from attached one or more controllers 200 while controller 200 is attached to main body apparatus 100.

Main body apparatus 100 may include a wireless communication unit that transmits and receives a wireless signal to and from a wireless relay connected to the Internet or an image output unit that outputs an image to external display 300 through dock 302.

### (b2: Controller 200)

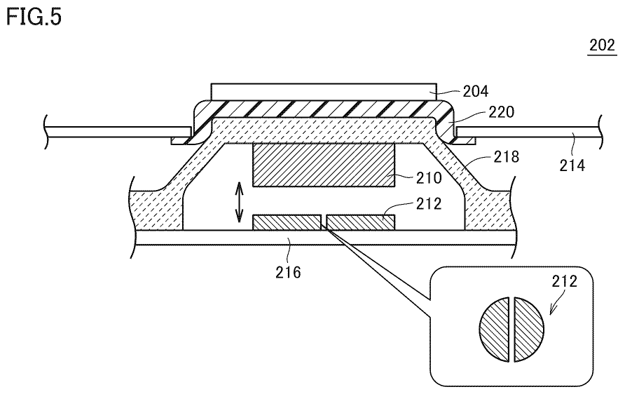

An exemplary cross-sectional structure of button 202 of controller 200 in system 1 according to the present embodiment will be described with reference to FIG. 5. Button 202 includes a key top 220 provided such that a part of button 202 projects through an opening provided in a housing 214 of controller 200. Key top 220 of button 202 is constructed independently of other buttons 202. Key top 220 may be composed of non-plastic and non-conductive resin. In a modification, key top 220 may be composed of a conductive material.

Touch sensor 204 is provided on an upper surface of key top 220 where the operation by the user is to be accepted.

On a side of key top 220 on the inside of controller 200, key rubber 218 is provided. Key rubber 218 as a whole is elastically deformed by force received from the upper surface of key top 220. Key rubber 218 may be composed of an elastically deformable material (for example, flexible and non-conductive resin or rubber).

A substrate 216 provided in the inside of controller 200 is provided with a fixed contact 212 composed of two separate conductors. A portion of key rubber 218 opposed to fixed contact 212 is provided with a moving contact 210. Moving contact 210 is composed, for example, of a conductive substance such as conductive carbon. As key top 220 is pressed, key rubber 218 and moving contact 210 move toward the inside of controller 200 and moving contact 210 comes in contact with fixed contact 212, so that the two conductors that form fixed contact 212 are electrically connected to each other.

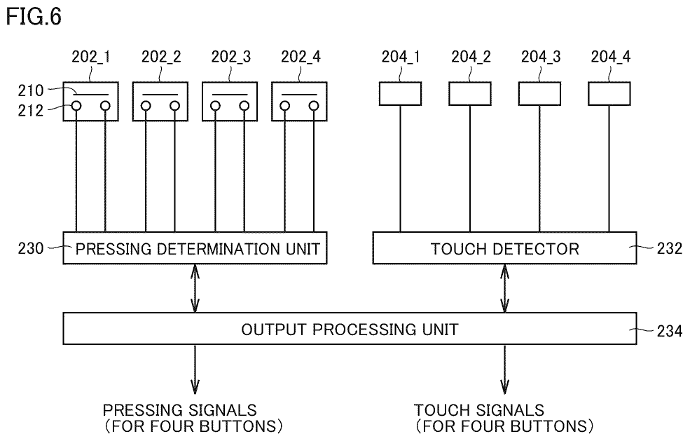

An exemplary hardware configuration of controller 200 in system 1 according to the present embodiment will be described with reference to FIG. 6. Controller 200 includes a pressing determination unit 230 electrically connected to four buttons 202_1 to 202_4, a touch detector 232 electrically connected to touch sensors 204_1 to 204_4, and an output processing unit 234.

Each of buttons 202_1 to 202_4 includes fixed contact 212 and moving contact 210 as features of a sensor capable of detecting pressing of buttons 202_1 to 202_4. A position of moving contact 210 is changed by the operation by the user, which allows conduction of fixed contact 212. Pressing determination unit 230 determines whether or not corresponding button 202 is being pressed based on a state of conduction of fixed contact 212.

Each of touch sensors 204_1 to 204_4 varies a capacitance thereof, for example, in accordance with a distance from the finger of the user. Touch detector 232 determines whether or not corresponding button 202 has been touched based on the capacitance produced in each of touch sensors 204_1 to 204_4. In this case, whether or not each of buttons 202 has been touched can digitally be detected.

Furthermore, in which direction of button 202 the finger of the user is present may be detected based on the capacitance produced in each of touch sensors 204_1 to 204_4. In this case, a direction of movement of touch to button 202 can be detected. In other words, a gesture by the user onto button 202 can be detected.

A method of detection by touch sensor 204 is not limited to the method based on the capacitance, but any method such as an ultrasonic method, an optical method, a resistive method may be adopted.

Output processing unit 234 outputs a result of determination by pressing determination unit 230 and touch detector 232. For example, output processing unit 234 outputs a pressing signal indicating whether or not each of buttons 202_1 to 202_4 is being pressed and a touch signal indicating a state of touch to each of buttons 202_1 to 202_4.

Output processing unit 234 may include a circuit that generates a wireless signal and/or a wired signal for transmission and reception of the pressing signal and the touch signal to and from main body apparatus 100.

The touch signal outputted from output processing unit 234 may be a signal indicating whether or not button 202 is being touched (for example, having two values of “ON” when button 202 is determined as being touched and “OFF” otherwise) or a signal indicating each of approach and contact to button 202 (for example, having three values of “1” when button 202 is approached but not contacted, “2” when button 202 is contacted, and “0” otherwise). Alternatively, the touch signal may be a signal indicating in an analog manner, a degree of approach in accordance with the capacitance produced in touch sensor 204 (for example, a value standardized within a range from 0 to 100, with a contacted state being defined as 100).

Processing for determining whether or not there is touch or determining a state of touch may be implemented in controller 200, in main body apparatus 100, or in both of them.

According to a structure as shown in FIGS. 5 and 6, whether or not button 202 is being pressed and touch to button 202 can be detected.

FIG. 5 shows an exemplary structure in which touch sensor 204 is provided in the upper surface of button 202 where the operation by the user is to be accepted. Without being limited as such, touch sensor 204 may be provided at any position so long as it is able to detect touch to button 202.

Instead of providing touch sensor 204 for each button 202, touch sensor 204 in common to a plurality of buttons 202 may be provided. For example, the touch sensor may be provided on an inner surface side of housing 214 of controller 200 shown in FIG. 5 to cover an area where buttons 202_1 to 202_4 are present, or a plurality of touch sensors not more than four or not less than five may be provided in the vicinity of buttons 202_1 to 202_4. In this case, whether or not one or more buttons 202 are approached or contacted can be detected (calculated) based on a touch position (a position where approach or contact of the finger of the user is detected) detected by the touch sensor.

### (b3: Modification)

Though an exemplary configuration of controller 200 that can be held by the user is shown, the configuration that allows detection of pressing of and touch to the button by the user may be adopted, for example, for a stationary controller. The stationary controller includes, for example, a joystick to be operated with the user's left hand and a plurality of buttons (for example, six buttons in total provided in correspondence with the forefinger, the middle finger, and the ring finger, two buttons for each of these fingers) to be operated with the user's right hand. The stationary controller may be provided as being integrated with a stationary game device or used as being placed on a floor surface. Each button may be provided with the touch sensor as described above.

In each of the controllers, a direction input portion (the analog stick, the slide stick, the joystick, or the like) is not an essential feature, and a button (and a touch sensor) alone may be provided. The number of buttons and a pattern of arrangement thereof can also freely be designed.

An exemplary user experience provided by system 1 according to the present embodiment will be described below. In the user experience which will be described below, processing for changing an image outputted from main body apparatus 100 in accordance with the operation by the user onto controller 200 is performed.

### C. Exemplary User Experience 1

Processing for moving a cursor (which will also be referred to as “cursor movement processing” below) for selection of any one of a plurality of shown items will be described as an exemplary user experience.

### (c1: Exemplary Cursor Movement Processing 1)

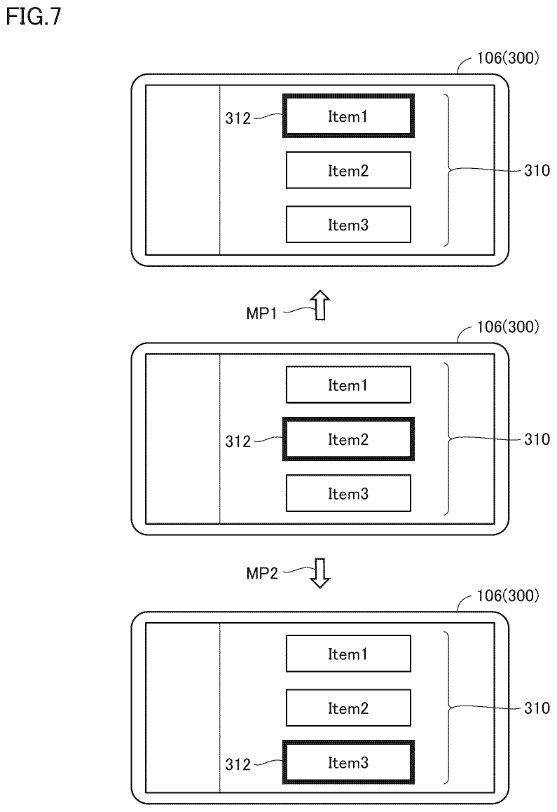

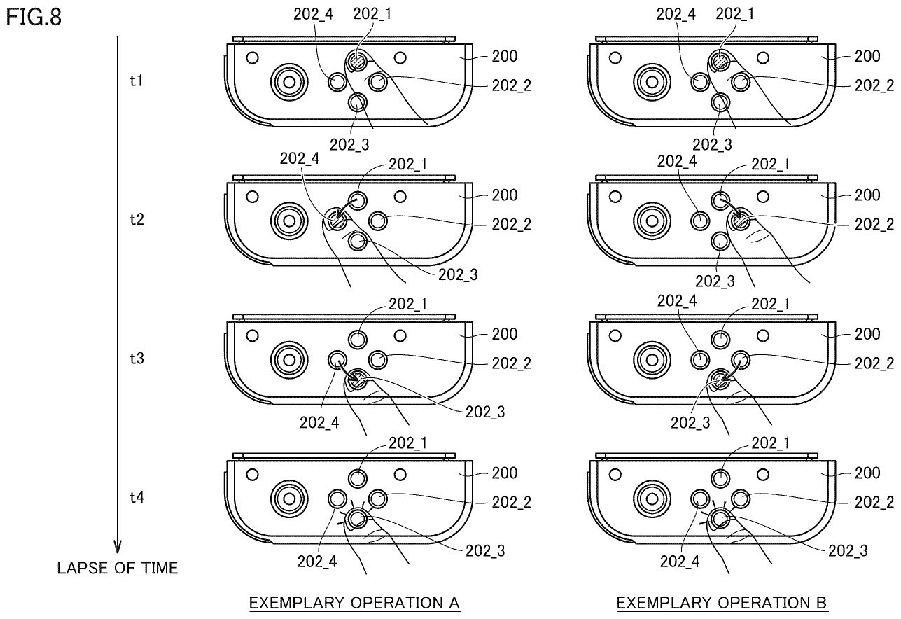

Exemplary cursor movement processing in the system according to the present embodiment will be described with reference to FIG. 7. An exemplary operation by the user corresponding to the cursor movement processing shown in FIG. 7 will be described with reference to FIG. 8.

Referring to FIG. 7, a plurality of items are shown as selection candidates, and a cursor 312 for selection of one of the plurality of items included in an item group 310 is shown. As the user operates controller 200, cursor 312 can be moved to select another item.

FIG. 7 illustrates as exemplary movement of cursor 312, movement processing MP1 to move cursor 312 to an item adjacent in an upward direction and movement processing MP2 to move cursor 312 to an item adjacent in a downward direction.

FIG. 8 shows an exemplary operation A onto controller 200 corresponding to movement processing MP1 in FIG. 7 and an exemplary operation B onto controller 200 corresponding to movement processing MP2 in FIG. 7.

As shown in exemplary operations A and B, the operation by the user to sequentially touch (approach or contact) at least two buttons 202 with the finger of the user himself/herself will also be referred to as a “movement operation” below. Main body apparatus 100 performs various types of processing based on the order of buttons 202 touched in the movement operation by the user. In other words, processing to be performed is determined in accordance with button 202 touched immediately before ultimately touched button 202 or button 202 touched before that, in a series of movement operations.

According to exemplary operations A and B, as successive touch to three different buttons 202 of controller 200 is detected, processing for moving cursor 312 is performed. In other words, in exemplary operations A and B, the movement operation of interest includes sequential touch of the finger of the user to at least three buttons 202.

Exemplary operation A is an exemplary operation by the user to successively touch three buttons 202 counterclockwise. More specifically, the user touches button 202_1 at time t1, touches button 202_4 at time t2 that follows, and touches button 202_3 at time t3 that follows. In response to touch to three buttons 202 for a time period from time t1 to time t3, cursor 312 moves to an item adjacent in the upward direction by movement processing MP1 shown in FIG. 7.

Furthermore, the user is assumed to press at time t4 following time t3, button 202_3 that the user has been touching. Then, selection of the item by cursor 312 at time t4 is fixed.

Exemplary operation B is an exemplary operation by the user to successively touch three buttons 202 clockwise. More specifically, the user touches button 202_1 at time t1, touches button 202_2 at time t2 that follows, and touches button 202_3 at time t3 that follows. In response to touch to three buttons 202 for the period from time t1 to time t3, cursor 312 moves to an item adjacent in the downward direction by movement processing MP2 shown in FIG. 7.

Furthermore, the user is assumed to press at time t4 following time t3, button 202_3 that the user has been touching. Then, selection of the item by cursor 312 at time t4 is fixed.

The operation to fix selection of the item may thus be performed when the user presses button 202 that the user has been touching while cursor 312 has selected a target item. At this time, whichever button 202 may ultimately be touched in the movement operation, processing for fixing selection of the item may be performed in response to pressing of that button 202. In other words, any type of button 202 for performing processing for fixing selection of the item may be applicable.

Alternatively, the processing for fixing selection of the item may be performed based on pressing of button 202 last in the movement operation while the finger of the user is touching that button 202. In other words, the processing for fixing selection of the item by pressing of button 202_3 at time t4 in exemplary operations A and B may be performed on condition that a state where the finger of the user is touching button 202_3 is maintained. When button 202 last in the movement operation is pressed again after touch of the finger of the user to that button 202 is cancelled (an approached or contacted state is cancelled), a function allocated in advance to that button 202 may be performed.

When the movement operation to sequentially touch at least three buttons 202 with the finger of the user is performed as shown at time t1 to time t3 in exemplary operations A and B, main body apparatus 100 performs cursor movement processing (first processing) based on the order of buttons 202 touched in the movement operation. At this time, different cursor movement processing is performed depending on aspects of the movement operation to sequentially touch at least three buttons 202 with the finger of the user. In other words, main body apparatus 100 makes processing aspects in the cursor movement processing different, depending on whether the order of buttons 202 touched in the movement operation is a clockwise order or a counterclockwise order.

As shown at time t4 in exemplary operations A and B, main body apparatus 100 performs the processing for fixing selection of the item (second processing) based on pressing of ultimately touched button 202 among the plurality of buttons 202 after the cursor movement processing (first processing) is performed.

In the exemplary operation shown in FIG. 8, when button 202 is pressed while the cursor movement processing is not being performed, the processing for fixing selection of the item is not performed. When button 202 alone is pressed while the cursor movement processing is not being performed, no processing may be performed. The function allocated in advance to pressed button 202 may be performed, and in this case, a function to fix selection of the item may be allocated to any one of buttons 202.

Button 202 for performing the processing for fixing selection of the item while the cursor movement processing is being performed does not have to be limited to ultimately touched button 202. In other words, main body apparatus 100 may perform the processing for fixing selection of the item (second processing) in response to pressing of any specific button 202 among the plurality of buttons 202 while the cursor movement processing is being performed. Alternatively, whichever button 202 may be pressed, the processing for fixing selection of the item may be performed.

Though exemplary operations A and B show an example where only a single button 202 is touched at each time point for the sake of convenience of description, without being limited as such, the cursor movement processing may be performed even when a plurality of buttons 202 are simultaneously touched at a certain time point.

More specifically, when touch to another button 202 adjacent to certain button 202 is detected following touch to that certain button 202, regardless of whether or not touch to previously touched button 202 continues, two buttons 202 may be determined as having successively been touched. In other words, the fact that previously touched button 202 is no longer touched when two buttons 202 are successively touched does not have to be set as a determination condition. This is because, for example, when buttons 202 are arranged in proximity, another button 202 may also be touched while previously touched button 202 is kept touched.

On the other hand, the fact that touch to previously touched button 202 is no longer detected may be set as the determination condition. Specifically, only when touch to previously touched button 202 is no longer detected and then touch to button 202 adjacent to that button 202 is detected, two buttons 202 may be determined as having successively been touched. At this time, even when touch to yet another button 202 in addition to adjacent button 202, yet another button 202 being adjacent to adjacent button 202, is detected, at least two buttons 202 may be determined as having successively been touched.

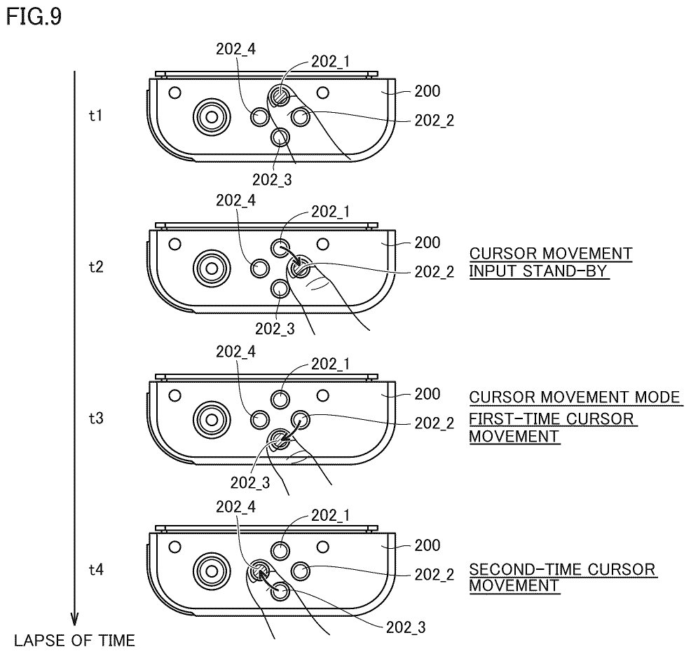

Another exemplary operation by the user corresponding to the cursor movement processing in the system according to the present embodiment will be described with reference to FIG. 9. An exemplary operation where the user successively touches three buttons 202 clockwise and thereafter further touches another button 202 is shown. More specifically, the user touches button 202_1 at time t1, touches button 202_2 at time t2 that follows, touches button 202_3 at time t3 that follows, and touches button 202_4 at time t4 that follows.

As two buttons 202 are touched at time t1 and time t2, transition to a state of cursor movement input stand-by is made. As button 202_3 is further touched at time t3 in the state of cursor movement input stand-by, a cursor movement mode is activated and cursor 312 moves.

The cursor movement mode refers to a state where, upon detection of touch to certain button 202, the cursor movement processing is performed based on positional relation between that touched button 202 and button 202 touched immediately before. Cursor movement input stand-by refers to a state of stand-by for the operation by the user (touch to specific button 202) for activation of the cursor movement mode.

For example, as button 202_4 is touched at time t4, cursor 312 further moves. Similarly thereafter, as buttons 202 are successively touched, cursor 312 continues movement in correspondence with the order of touch to buttons 202.

Though FIG. 9 shows the example in which buttons 202 are touched in a certain order (clockwise) for the sake of convenience of description, in the cursor movement mode, touch to buttons 202 that satisfies a predetermined rule (for example, successive touch to adjacent buttons 202) may be handled as a valid operation. Therefore, even when buttons 202 are successively touched counterclockwise after buttons 202 are successively touched clockwise, the cursor movement processing may be kept performed. When buttons 202 are successively touched counterclockwise, cursor 312 may move in a direction different from the direction at the time of successive clockwise touch to buttons 202.

When certain button 202 is touched and thereafter another button 202 is not touched within a predetermined time period, on the other hand, cursor movement input stand-by or the cursor movement mode may be cancelled. In other words, when the predetermined time period has elapsed since stop of movement of detected touch, cursor movement input stand-by or the cursor movement mode may be cancelled. Similarly, when the predetermined time period has elapsed since no button 202 was touched any longer, cursor movement input stand-by or the cursor movement mode may be cancelled.

The processing for fixing selection of the item may be performed based on pressing of button 202 before lapse of a predetermined time period since the cursor movement processing was performed. Specifically, the processing for fixing selection of the item may be performed when any button 202 is pressed before lapse of the predetermined time period since touch of the finger of the user to button 202 last in the movement operation or before lapse of the predetermined time period since cancellation of touch to button 202 touched last in the movement operation.

In addition, cursor movement input stand-by or the cursor movement mode may be cancelled also when another button 202 is touched following touch to certain button 202 and these two buttons 202 are not adjacent to each other. For example, when buttons 202 opposed to each other are touched instead of successive touch to adjacent buttons 202, cursor movement input stand-by or the cursor movement mode may be cancelled.

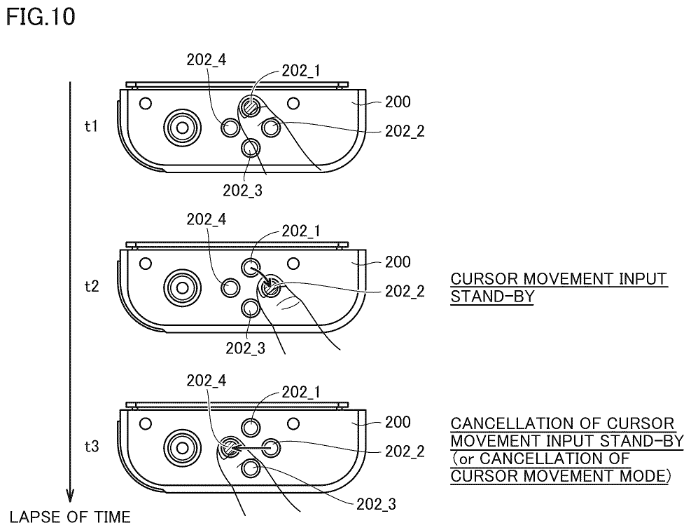

An exemplary operation by the user in which cursor movement input stand-by or the cursor movement mode is cancelled in the system according to the present embodiment will be described with reference to FIG. 10. It is assumed that the user touches button 202_1 at time t1 and touches button 202_2 at time t2 that follows. Transition to the state of cursor movement input stand-by is made by the operation by the user at time t1 and time t2. In the state of cursor movement input stand-by, buttons 202 are expected to successively be touched clockwise.

At time t3 that follows, the user is assumed to touch button 202_4 opposed to button 202_2, instead of button 202_3 adjacent to button 202_2. Then, this operation does not comply with the rule of successive touch to adjacent buttons 202, and cursor movement input stand-by is cancelled. When touch to button 202_4 opposed to button 202_2 is detected following touch to button 202_2 also in an example where the cursor movement mode has been activated, the cursor movement mode may similarly be cancelled.

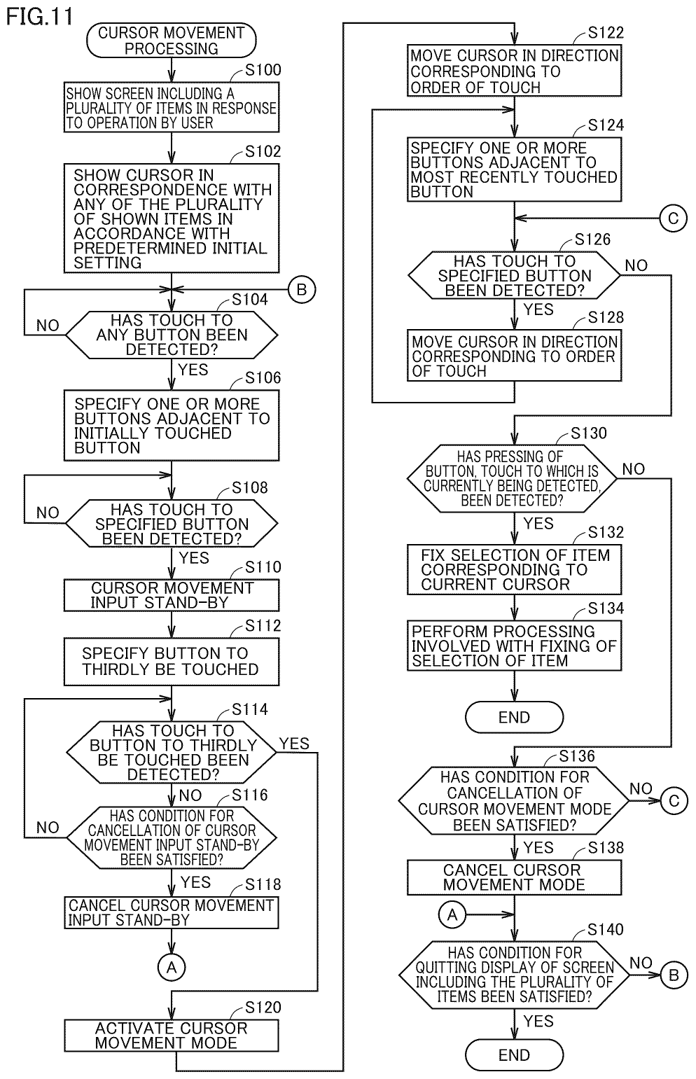

A processing procedure in the cursor movement processing in the system according to the present embodiment will be described with reference to FIG. 11. Each step shown in FIG. 11 may be implemented by execution of system program 122 and/or application program 124 by one or more processor 102 of main body apparatus 100.

Processor 102 of main body apparatus 100 causes display of a screen including a plurality of items in response to the operation by the user (step S100) and causes display of cursor 312 in correspondence with any item of the plurality of shown items in accordance with predetermined initial setting (step S102).

In succession, processor 102 determines whether or not touch to any button 202 has been detected (step S104). Button 202, touch to which has been detected in step S104, is referred to as “initially touched button 202.” When touch to no button 202 is detected (NO in step S104), processing in step S104 is repeated.

When touch to any button 202 is detected (YES in step S104), processor 102 specifies one or more buttons 202 adjacent to initially touched button 202 (step S106). Processor 102 then determines whether or not touch to specified button 202 has been detected (step S108). When touch to specified button 202 has not been detected (NO in step S108), processing in step S108 is repeated. For example, when touch (not shown) to a button other than the specified button(s) has been detected, the button, touch to which has been detected, may be defined as the “initially touched button” and processing in step S106 or later may be performed.

When touch to specified button 202 has been detected (YES in step S108), processor 102 makes transition to the state of cursor movement input stand-by (step S110). The button, touch to which has been detected in step S108, is referred to as “secondly touched button 202.” Processor 102 then specifies button 202 to thirdly be touched based on positional relation between initially touched button 202 and secondly touched button 202 (step S112).

When touch to an adjacent button has not been detected within a predetermined time period from detection of touch to initially touched button 202, transition to the state of cursor movement input stand-by does not have to be made.

In succession, processor 102 determines whether or not touch to button 202 to thirdly be touched has been detected (step S114). When touch to button 202 to thirdly be touched has not been detected (NO in step S114), processor 102 determines whether or not a condition for cancellation of cursor movement input stand-by has been satisfied (step S116).

Exemplary conditions for cancellation of the state of cursor movement input stand-by include (1) a condition that button 202 to thirdly be touched is not touched within a predetermined time period from touch to initially touched button 202, (2) a condition that a state where no button 202 is touched has continued longer than the predetermined time period, and the like. Only at least one of these two conditions may be adopted as the condition for cancellation of cursor movement input stand-by, or another condition may be included in the condition for cancellation of cursor movement input stand-by.

When the condition for cancellation of cursor movement input stand-by has been satisfied (YES in step S116), processor 102 cancels the state of cursor movement input stand-by (step S118). Processor 102 then determines whether or not a condition for quitting display of the screen including a plurality of items has been satisfied (step S140).

When the condition for cancellation of cursor movement input stand-by has not been satisfied (NO in step S116), processing in step S114 is repeated.

When touch to button 202 to thirdly be touched has been detected (YES in step S114), processor 102 activates the cursor movement mode (step S120) and moves shown cursor 312 in a direction corresponding to the order of the secondly touched button and thirdly touched button 202 (step S122). Processor 102 then specifies one or more buttons adjacent to the most recently touched button (step S124).

In succession, processor 102 determines whether or not touch to any button 202 specified in step S124 has been detected (step S126). When touch to any button 202 specified in step S124 has been detected (YES in step S126), processor 102 moves shown cursor 312 in the direction corresponding to the order of detected touch (step S128). Processing in step S124 or later is then repeated.

Thus, when the movement operation to sequentially touch at least two buttons 202 with the finger of the user is performed, main body apparatus 100 performs the cursor movement processing (first processing) based on the order of buttons 202 touched in the movement operation.

When touch to button 202 specified in step S124 has not been detected (NO in step S126), processor 102 determines whether or not pressing of button 202, touch to which is currently being detected, has been detected (step S130). When pressing of button 202, touch to which is currently being detected, has been detected (YES in step S130), processor 102 fixes selection of the item corresponding to current cursor 312 (step S132). In succession, processor 102 performs processing involved with fixing of selection of the item (step S134). Processing involved with fixing of selection of the item may be, for example, such processing as showing details of the selected item. The cursor movement processing then ends.

When pressing of button 202, touch to which is currently being detected, has not been detected (NO in step S130), processor 102 determines whether or not the condition for cancellation of the cursor movement mode has been satisfied (step S136).

Exemplary conditions for cancellation of the cursor movement mode include (1) a condition that another button 202 is not touched within a predetermined time period from most recent touch to button 202, (2) a condition that a state where no button 202 is touched has continued longer than the predetermined time period, (3) a condition that button 202 other than adjacent button 202 has been touched, and the like. Only at least one of these three conditions may be adopted as the condition for cancellation of the cursor movement mode, or another condition may be included in the condition for cancellation of the cursor movement mode.

When the condition for cancellation of the cursor movement mode has not been satisfied (NO in step S136), processing in step S126 or later is repeated.

When the condition for cancellation of the cursor movement mode has been satisfied (YES in step S136), processor 102 cancels the cursor movement mode (step S138). Processor 102 then determines whether or not the condition for quitting display of the screen including the plurality of items has been satisfied (step S140).

When the condition for quitting display of the screen including the plurality of items has not been satisfied (NO in step S140), processing in step S104 or later is repeated.

When the condition for quitting display of the screen including the plurality of items has been satisfied (YES in step S140), the process ends.

Thus, in the cursor movement processing according to the present embodiment, cursor 312 is moved on condition that touch to three different buttons 202 of controller 200 has been detected. By setting touch to three different buttons 202 as the condition, even when the user erroneously operates two buttons 202, unintended movement or the like of cursor 312 can be prevented.

Correspondence between a pattern of the order of touch to buttons 202 by the user (for example, clockwise or counterclockwise touch) and a direction and an amount of movement of cursor 312 can freely be designed.

Though exemplary processing for moving cursor 312 in response to detection of touch to three different buttons 202 is shown in the description above, without being limited as such, cursor 312 may be moved in response to detection of touch to two different buttons 202 or detection of touch to four (or at least four) different buttons 202. For example, when detection of touch to two different buttons 202 is set as the condition, cursor 312 may be moved in a stage of detection of touch to another button 202 following detection of touch to first button 202.

### (c2: Exemplary Cursor Movement Processing 2)

In exemplary cursor movement processing 1 described above, transition to the state of cursor movement input stand-by is made by touch to two buttons 202. The operation for transition to the state of cursor movement input stand-by may include not only touch to two buttons 202 but also simultaneous pressing of two buttons 202.

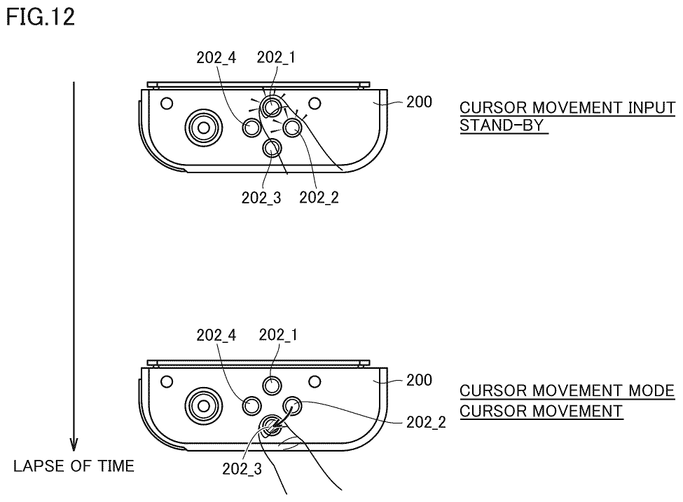

An exemplary operation by the user for transition to the state of cursor movement input stand-by in the system according to the present embodiment will be described with reference to FIG. 12. The user is assumed to simultaneously press buttons 202_1 and 202_2. Buttons 202_1 and 202_2 that have been pressed are adjacent to each other, and as a result of this operation, transition to the state of cursor movement input stand-by is made. When the user touches button 202_3 in succession, the cursor movement mode is activated and cursor 312 moves to a position adjacent in the downward direction by movement processing MP2 shown in FIG. 7.

The cursor movement mode is activated also in response to touch to button 202_4 rather than button 202_3 by the user, and cursor 312 moves to a position adjacent in the upward direction by movement processing MP1 shown in FIG. 7.

When the user touches buttons 202_1 and 202_2 at the same timing and thereafter maintains touch to button 202_2 but cancels touch to button 202_1, in response to touch to button 202_3 that follows, the cursor movement mode may be activated and cursor 312 may be moved to the position adjacent in the downward direction. At this time, even when button 202_1 and/or button 202_4 are/is touched, the cursor movement mode does not have be activated and cursor 312 does not have to be moved.

The condition for transition to the state of cursor movement input stand-by may thus include the operation to simultaneously press two adjacent buttons 202. In this exemplary processing, the movement operation to sequentially touch at least two buttons 202 with the finger of the user is not necessarily required, and processing is performed based on combination of pressing of button 202 and touch to button 202.

### (c3: Exemplary Cursor Movement Processing 3)

A function specific to the cursor movement mode may be allocated to button 202 of controller 200 in the cursor movement mode.

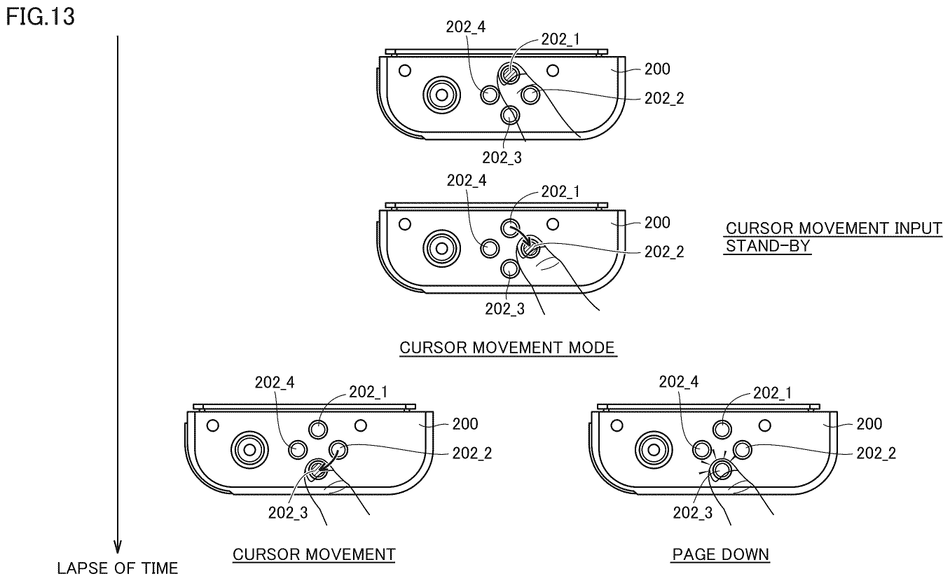

Exemplary allocation of the function in the cursor movement mode in the system according to the present embodiment will be described with reference to FIG. 13. It is assumed that the user touches button 202_1 and thereafter touches button 202_2. As a result of this operation, transition to the state of cursor movement input stand-by is made.

When the user touches button 202_3 in the state of cursor movement input stand-by, the cursor movement mode is activated and cursor 312 moves to the position adjacent in the downward direction by movement processing MP2 shown in FIG. 7.

In the cursor movement mode, a function specific to the cursor movement mode may be allocated to at least one of buttons 202_1 to 202_4 of controller 200. Exemplary functions specific to the cursor movement mode include enter, cancel, page down, page up, and the like.

FIG. 13 shows an example in which “page down” is allocated to button 202_3. When the user presses button 202_3, processing for page down is performed. Similarly, when another button 202 is pressed, the function allocated to each button 202 may be performed.

The function specific to the cursor movement mode may be allocated to at least one of buttons 202_1 to 202_4 of controller 200 in the cursor movement mode, and when the cursor movement mode is cancelled, other functions may be allocated to buttons 202_1 to 202_4.

Thus, based on pressing of at least one of the plurality of buttons 202 following the movement operation, the function (second processing) specific to the cursor movement mode may be performed.

The cursor movement mode may be cancelled when a state where no button 202 is touched has continued for a predetermined time period (for example, three seconds) or longer. For example, the predetermined time period may be set in consideration of an operation time period necessary for pressing button 202 from the state of touch to button 202 by the user.

### (c4: Exemplary Cursor Movement Processing 4)

The user may operate not only a single controller 200 but also two controllers 200 simultaneously (see FIG. 2 or the like). Alternatively, a button group, touch to which can be detected, may be provided on each of the right side and the left side of a single controller 200, and these button groups may simultaneously be operated. Even in such a case, the cursor movement processing described above can be performed.

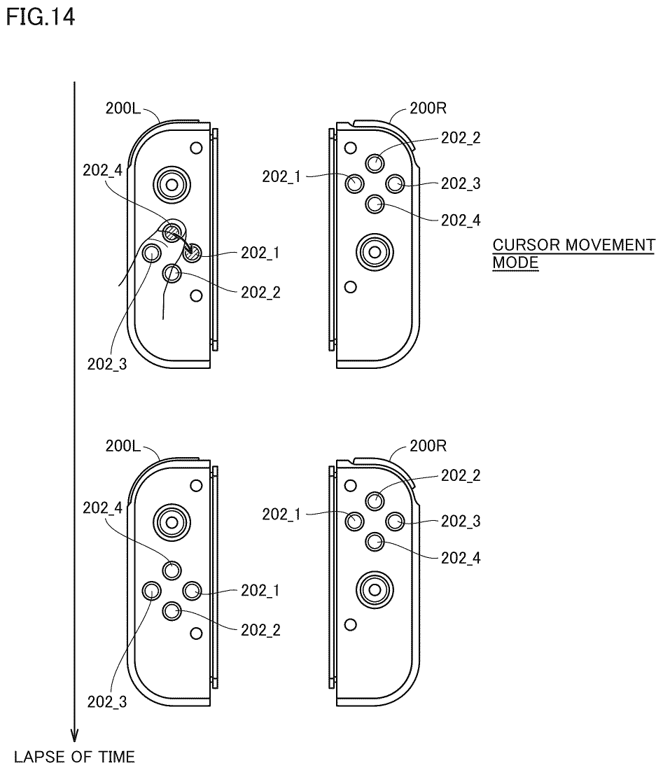

An exemplary operation by the user corresponding to the cursor movement processing in using two controllers 200 in the system according to the present embodiment will be described with reference to FIG. 14. For example, the user operates a controller 200L with the left hand and operates a controller 200R with the right hand.

It is assumed that the user touches button 202_4 of controller 200L and in succession touches button 202_1. Then, the cursor movement mode is activated via cursor movement input stand-by. In the cursor movement mode, the function specific to the cursor movement mode may be allocated to buttons 202 in controller 200L and controller 200R.

For example, such functions as enter, cancel, page down, and page up may be allocated to at least one of buttons 202_1 to 202_4 of controller 200R.

In addition, movement to a position adjacent to the right, movement to a position adjacent in the downward direction, movement to a position adjacent to the left, and movement to a position in the upward direction for movement of cursor 312 may be allocated to respective buttons 202_1 to 202_4 of controller 200L. In other words, in the cursor movement mode, the user can move cursor 312 by pressing any one of buttons 202_1 to 202_4 of controller 200L.

Thus, based on pressing of at least one of buttons 202 of controller 200L rather than buttons 202 of controller 200R following the movement operation onto buttons 202 of controller 200R, the function specific to the cursor movement mode (first processing) may be performed.

It may be difficult, on the other hand, to determine the user's intention simply based on touch by the user to any one button 202 of buttons 202_1 to 202_4 of controller 200L, and specific processing in the cursor movement mode does not have to be performed.

The cursor movement mode may be activated by the operation onto button 202 of controller 200R.

### (c5: Exemplary Cursor Movement Processing 5)

Though exemplary processing for moving cursor 312 along items in a linear arrangement is illustrated in the description above, the items may be arranged in rows and columns.

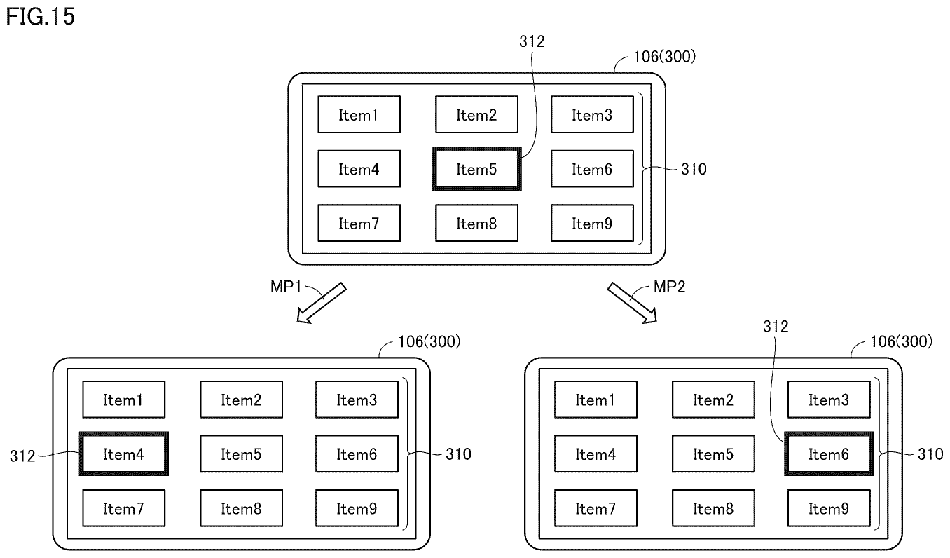

Another exemplary cursor movement processing in the system according to the present embodiment will be described with reference to FIG. 15. Cursor 312 for selection of any one item in item group 310 composed of items arranged in rows and columns may be configured as being movable.

In the example shown in FIG. 15, movement processing for moving cursor 312 to a position adjacent to the right or the left may be performed or movement processing for moving the cursor in a diagonal direction may be performed in accordance with the operation by the user. Furthermore, rather than movement of cursor 312 to an adjacent position, the cursor may be moved to a position a plurality of items ahead such as a position two items ahead.

The number of items over which cursor 312 is moved and a method of arrangement of the items can thus freely be designed.

### D. Exemplary User Experience 2

Game processing that proceeds based on a result of detection of pressing of and touch to button 202 by the user will be described as another exemplary user experience.

### (d1: Game Processing 1)

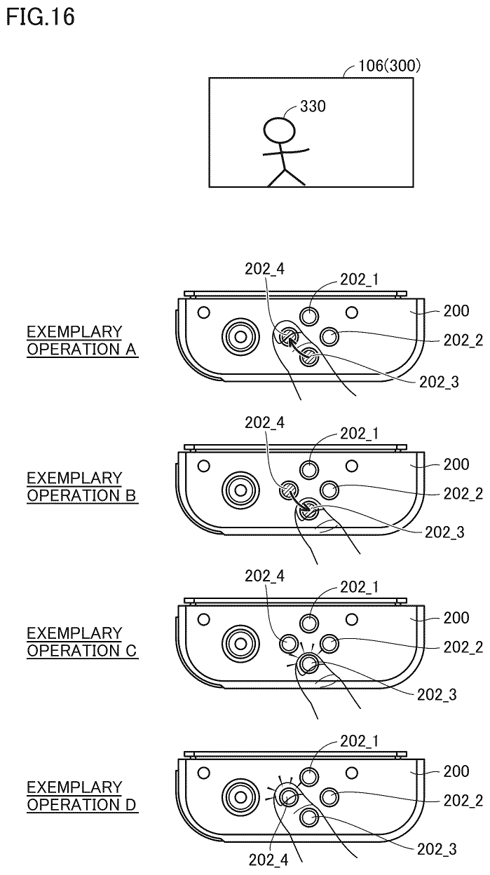

Exemplary game processing in the system according to the present embodiment will be described with reference to FIG. 16. The user operates a character object 330 with controller 200. The user can move character object 330 by operating direction indicator 208.

Exemplary operations A and B are examples where a plurality of buttons 202 are successively touched to exhibit techniques (skills) set in advance for character object 330.

More specifically, in exemplary operation A, the user touches button 202_3 and in succession touches button 202_4 to exhibit a skill 1 of character object 330. In exemplary operation B, the user touches button 202_4 and in succession touches button 202_3 to exhibit a skill 2 of character object 330. In the middle of the movement operation, change of an appearance of character object 330 caused by the movement operation may be avoided. In contrast, an effect or the like suggesting that the movement operation is being performed may be shown.

Thus, on condition that touch to a plurality of different buttons 202 is detected, character object 330 may be caused to perform a specific operation. In other words, when the movement operation to sequentially touch at least two buttons 202 with the finger of the user is performed, main body apparatus 100 allows exhibition of the skill (first processing) based on the order of buttons 202 touched in the movement operation. By setting detection of touch to the plurality of different buttons 202 as the condition, an operation or the like of character object 330 unintended by the user can be prevented.

Exemplary operations C and D are examples where character object 330 is operated by pressing of button 202 following touch to button 202.

More specifically, in exemplary operation C, as the user touches button 202_3, a state of being ready for attack is set, and when the user presses button 202_3 in succession, character object 330 makes an attack.

In exemplary operation D, as the user touches button 202_4, a state of being ready for jump is set, and when the user presses button 202_4 in succession, character object 330 jumps.

For such operations as attack and jump performed as a result of pressing of button 202_3 and button 202_4, detection immediately before of touch to button 202_3 and button 202_4 may be set as the condition for performing the operation, or such detection does not have to be set as the condition for performing the operation. In the latter case, character object 330 performs a corresponding operation in response to pressing of button 202_3 and button 202_4.

The operation of character object 330 shown in FIG. 16 is by way of example, and the operation of character object 330 corresponding to touch to a plurality of different buttons 202 and/or combination between touch to button 202 and pressing of button 202 can freely be designed.

### (d2: Game Processing 2)

Though the example in which the skill of character object 330 is exhibited in response to successive touch to the plurality of buttons 202 is shown in game processing 1 described above, pressing of button 202 may be included in the condition for exhibition.

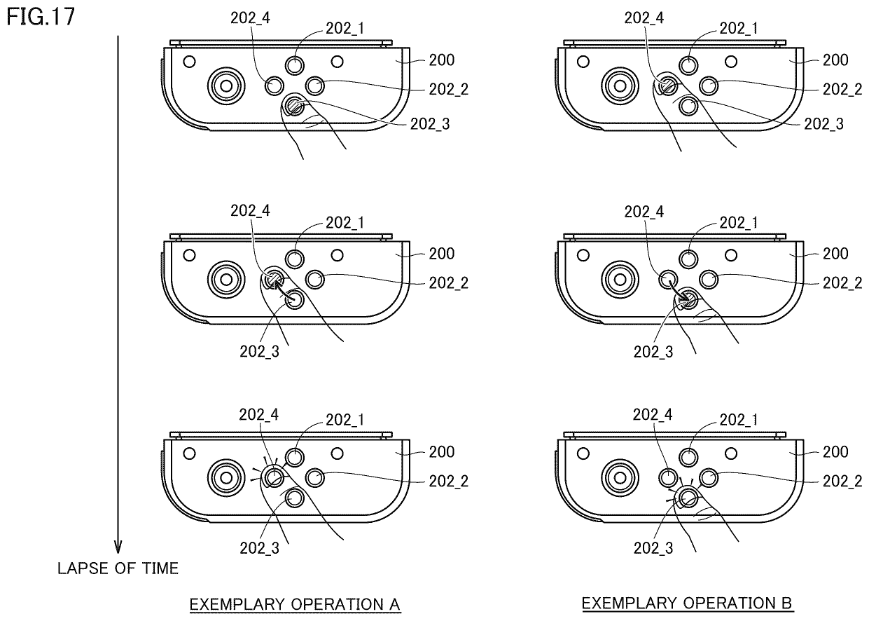

An exemplary operation by the user corresponding to the exemplary game processing in the system according to the present embodiment will be described with reference to FIG. 17. As a result of the operation by the user shown in FIG. 17, character object 330 operates as shown in FIG. 16.

Exemplary operations A and B are examples where the skill of character object 330 is exhibited by successive touch to the plurality of buttons 202 and then pressing of button 202.

More specifically, in exemplary operation A, the user touches button 202_3 and in succession touches button 202_4, and thereafter presses button 202_4 to exhibit skill 1 of character object 330.

In exemplary operation B, the user touches button 202_4 and in succession touches button 202_3, and thereafter presses button 202_3 to exhibit skill 2 of character object 330.

Thus, on condition that touch to a plurality of different buttons 202 is detected and then button 202 is pressed, character object 330 may be caused to perform the specific operation. In other words, main body apparatus 100 may perform exhibition of the skill (first processing) based on pressing of at least one of the plurality of buttons 202 following the movement operation. By setting pressing of button 202 as the condition in addition to detection of touch to the plurality of different buttons 202, the operation or the like of character object 330 unintended by the user can be prevented.

Though the skill may be exhibited whichever button 202 may be pressed, the skill may be exhibited, for example, based on pressing following the movement operation, of button 202 touched last in the movement operation as shown in exemplary operations A and B. Alternatively, a specific button for exhibition of the skill, which is to be pressed last to exhibit the skill, may be provided.

The skill may be exhibited based on pressing of button 202 last in the movement operation while the finger of the user keeps touching that button 202. In other words, for performing processing for exhibition of the skill as a result of pressing of button 202_4 or button 202_3 in exemplary operations A and B, a state of touch of the finger of the user to button 202_4 or button 202_3 being maintained may be set as the condition.

Alternatively, the skill may be exhibited based on pressing of button 202 last touched with the finger of the user in the movement operation before lapse of a predetermined time period since the finger of the user moved away from that button 202. The skill can be exhibited by pressing of button 202 within the predetermined time period since cancellation of touch to button 202. Therefore, even when the user unintentionally moves his/her finger from button 202, an operation in conformity with his/her intention can continue.

A function may be allocated to at least one or all of buttons 202_1 to 202_4 such that character object 330 performs a specific operation (for example, attack or jump) when at least one or all of the buttons is/are simply pressed (that is, in a state where touch to the same has not been detected immediately before).

### (d3: Game Processing 3)

The user may operate not only a single controller 200 but also two controllers 200 simultaneously (see FIG. 2 or the like). Even in such a case, the game processing described above can be performed.

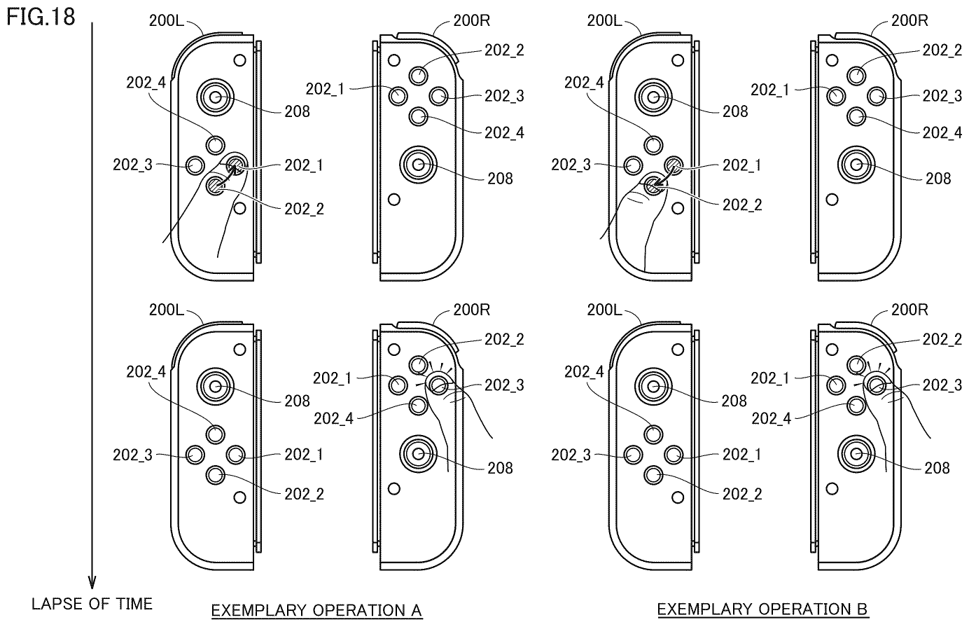

An exemplary operation by the user corresponding to the game processing in using two controllers 200 in the system according to the present embodiment will be described with reference to FIG. 18. Character object 330 operates as shown in FIG. 16 as a result of the operation by the user shown in FIG. 18.

Exemplary operations A and B are examples where the user successively touches the plurality of buttons 202 of controller 200L with the left hand and presses button 202 of controller 200R with the right hand to exhibit the skill of character object 330. More specifically, in exemplary operation A, skill 1 of character object 330 is exhibited as a result of touch by the user to button 202_2 of controller 200L, to both of buttons 202_2 and 202_1 in succession, and further to button 202_1, and thereafter pressing of button 202_3 of controller 200R.

The skill may thus be exhibited (first processing) based on pressing of at least one of buttons 202 of controller 200R rather than button 202 of controller 200L in succession to the movement operation onto button 202 of controller 200L.

For example, in game processing according to the related art, a specific skill is exhibited by pressing of button 202 in succession to successive input of predetermined directions by an operation onto direction indicator 208. In an example where such an operation by the user is adopted, direction indicator 208 is operated. Therefore, character object 330 may be moved in spite of the fact that movement of character object 330 is not intended.

In contrast, in game processing 3 described above, in exhibition of the skill, the operation onto direction indicator 208 is not necessary, and hence unintended movement of character object 330 is prevented.

### E. Exemplary User Experience 3

Controller 200 according to the present embodiment can detect approach of the finger of the user to button 202. Therefore, the operation by the user onto controller 200 can be estimated based on change in result of detection by touch sensors 204_1 to 204_4. Exemplary processing in which the operation by the user cam more precisely be detected will be described below.

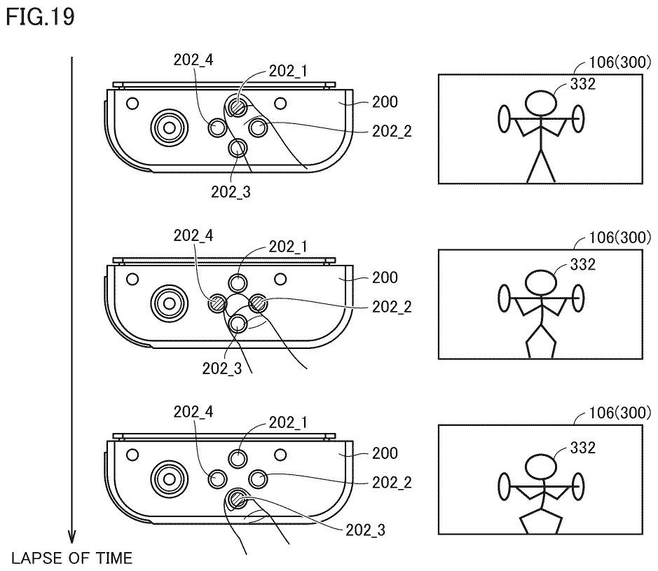

Yet another exemplary game processing in the system according to the present embodiment will be described with reference to FIG. 19. The user operates a character object 332 with controller 200. FIG. 19 shows an example where the user operates buttons 202_1 to 202_4 of controller 200 so that character object 332 performs such an operation as bending and stretching in an upward and downward direction.

As shown in FIG. 19, when such a movement operation as sequential touch to at least two buttons 202 with the finger of the user is performed, main body apparatus 100 performs the game processing (first processing) based on the order of buttons 202 touched in the movement operation.

More specifically, the user touches button 202_1 and in succession touches button 202_3. At this time, while the finger of the user moves from button 202_1 to button 202_3, the finger of the user approaches button 202_2 and button 202_4. In other words, touch sensor 204_2 and touch sensor 204_4 arranged in button 202_2 and button 202_4, respectively, output signals indicating approach of the finger of the user (a signal lower in degree of approach than in the case of contact of the finger of the user).

Main body apparatus 100 expresses a state intermediate between a state where character object 332 stretches to the maximum in the upward direction and a state where character object 332 bends down to the maximum in the downward direction based on the touch signal(s) from touch sensor 204_2 and/or touch sensor 204_4.

Thus, when the movement operation is such that the finger of the user sequentially touches button 202_1 and then touches button 202_3 different from button 202_2 and button 202_4 adjacent to button 202_1 among four buttons 202_1 to 202_4, main body apparatus 100 may perform the game processing based on touch of the finger of the user to button 202_2 and button 202_4 among four buttons 202_1 to 202_4.

As the processing for expressing this intermediate state, main body apparatus 100 may perform the game processing based on touch of the finger of the user to both of button 202_2 and button 202_4, or may perform the game processing based on touch of the finger of the user to one of button 202_2 and button 202_4.

At this time, identical game processing may be performed in both of a case where the finger of the user touches both of button 202_2 and button 202_4 and a case where the finger of the user touches only one of button 202_2 and button 202_4.

By adoption of such a configuration, even when the user unintentionally fails to touch button 202, display of an image in conformity with the original user's intention can be realized.

Though FIG. 19 illustrates a motion of the user between button 202_1 (touch sensor 204_1) and button 202_3 (touch sensor 204_3), similarly also in the case of the motion of the user between button 202_2 (touch sensor 204_2) and button 202_4 (touch sensor 204_4), the intermediate state can be expressed based on the touch signals from touch sensor 204_1 and touch sensor 204_3.

### F. Other Exemplary User Experiences

Other exemplary user experiences according to the present embodiment will now be described.

### (f1: Character Input Processing)

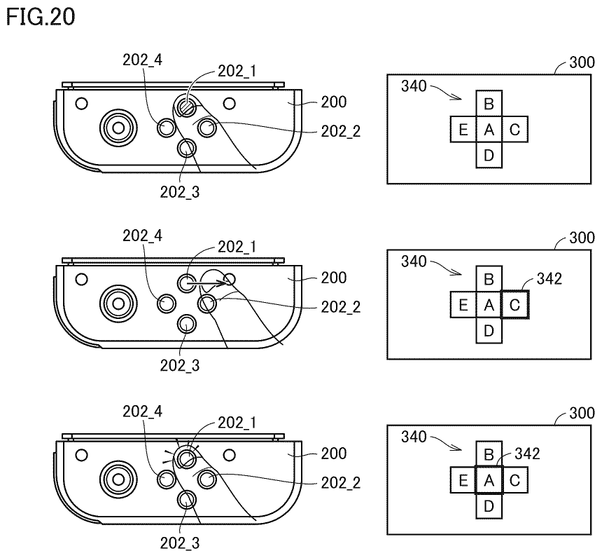

Exemplary character input processing in the system according to the present embodiment will be described with reference to FIG. 20. In the exemplary character input processing shown in FIG. 20, a direction of movement of touch to button 202 can be detected.

For example, a character candidate object 340 is shown in response to touch to button 202_1 by the user. Character candidate object 340 includes four characters (“B”, “C”, “D”, and “E” in the example shown in FIG. 20) brought in correspondence with four respective directions in which movement over button 202_1 is made. “A” is arranged in the center of character candidate object 340.

Though not shown, character candidate object 340 including other characters (for example, “F”, “G”, “H”, “I”, and “J”) is shown in response to touch to another button 202.

Specifically, one character (for example, “A”, “F”, . . . ) is allocated to each of buttons 202, and character candidate object 340 including the character (for example, “A”) allocated to touched button 202 and a plurality of characters (for example, “B”, “C”, “D”, and “E”) associated with the former character is shown in response to touch to any button 202.

When the user moves the finger over button 202 along any direction, a character corresponding to the direction is selected from among the plurality of associated characters included in character candidate object 340. FIG. 20 shows an example where the character “C” is selected. When button 202 is pressed while character candidate object 340 is shown, the character “A” arranged in the center of character candidate object 340 is selected. In selection of the character arranged in the center of character candidate object 340, the movement operation to sequentially touch at least two buttons 202 with the finger of the user is not necessarily required, and the character is selected based on combination of pressing of button 202 and touch to button 202.

Controller 200 can thus be used for efficient character input.

### (f2: Operation Guide Function)

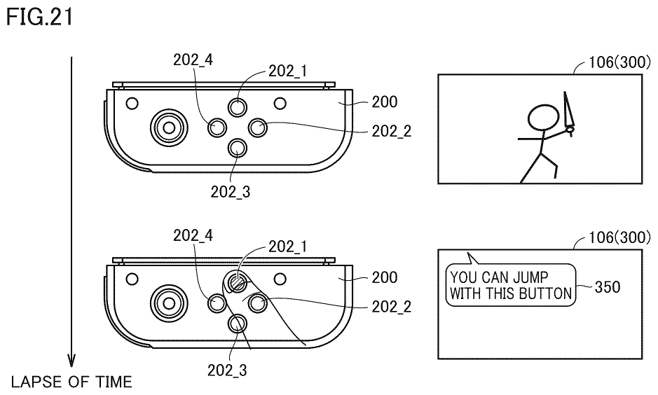

An exemplary operation guide function in the system according to the present embodiment will be described with reference to FIG. 21. In a state where any processing (for example, game processing) is being performed, a notification object 350 for explanation of a function or the like allocated to any touched button 202 may be shown in response to touch to that button 202

As such notification object 350 is shown, the user can readily know the function allocated to each button 202 of controller 200.

The operation guide function may include configurations (A) to (F) below. The operation guide function may include any one of the configurations below or a plurality of configurations among them. The operation guide function may include yet another configuration.

(A) When touched button 202 is pressed, display of notification object 350 corresponding to that button 202 may end. This is because the user seems to have understood the function allocated to that button 202 and then pressed that button 202.

(B) When button 202 is touched and a state that this button 202 is not pressed has continued for a predetermined time period or longer, notification object 350 may be shown.

In operation of controller 200 by the user, the user may unintentionally touch button 202. When notification object 350 is shown in such a case, the user may feel bothersome. Alternatively, in pressing of button 202 by the user, this button 202 is inevitably touched. When notification object 350 is shown in a situation where the user understands the function of button 202 and presses this button 202, the user may feel bothersome. Therefore, a predetermined time period before notification object 350 is shown may be set.

The predetermined time period may generally be set to a time period longer than a time period required for pushing of button 202. For example, the predetermined time period may be, for example, equal to or longer than 0.5 second, or for example, equal to longer than one second.

(C) When a state that notification object 350 is shown has continued for a predetermined time period or longer while button 202 is being touched but not pressed, display of notification object 350 may end. This is because the user has already visually recognized notification object 350 and display may not be necessary any longer. In this case, the predetermined time period during which notification object 350 is shown may be, for example, equal to or longer than two seconds.

(D) When first button 202 is touched and second button 202 different from first button 202 is touched, notification object 350 for explanation of the functions allocated to first button 202 and second button 202 does not have to be shown. When two buttons 202 are touched, it is unclear which of functions of buttons 202 the user desires to know, and the buttons may have erroneously been touched. In another example, all notification objects 350 corresponding to both of (a plurality of) touched buttons 202 may be shown.

(E) When first button 202 is touched and second button 202 different from first button 202 is pressed, notification object 350 for explanation of the function allocated at least to first button 202 does not have to be shown.

A case as above may include, for example, a case where second button 202 is pressed while first button 202 is being touched and a case where first button 202 is touched while second button 202 is being pressed. In any case, one button 202 may have unintentionally been touched in pressing of the other button 202, and the user may feel bothersome if notification object 350 for one button 202 is shown in such a case.

In a more specific example, in a state where first button 202 is being touched, when second button 202 is pressed before lapse of a predetermined time period necessary for display of notification object 350, notification object 350 corresponding to first button 202 does not have to be shown in spite of lapse of the predetermined time period. For example, when touch to first button 202 continues for a certain time period also after end of pressing of second button 202, notification object 350 may be shown.

In yet another specific example, when first button 202 is touched while second button 202 is being pressed, normally, notification object 350 corresponding to first button 202 does not have to be shown in spite of lapse of a predetermined time period necessary for display of notification object 350. Similarly, when touch to first button 202 continues even after end of pressing of second button 202, notification object 350 may be shown.

(F) Likeliness of display of notification object 350 may be varied depending on a status of a game. For example, when a new function or a function different from before is allocated to certain button 202 with progress of the game, in response to touch to that button 202, notification object 350 may be more likely to be shown than before.

Alternatively, for example, at the time of first play of a game, notification object 350 may be more likely to be shown, or after lapse of a predetermined time period or longer since previous play of the game, notification object 350 may be more likely to be shown at the time of resumption of the game after it is once quitted or suspended.

Alternatively, when notification object 350 corresponding to certain button 202 has already been shown or when button 202 has ever been pressed, subsequently, notification object 350 corresponding to that button 202 may be less likely to be shown.

“Being more likely to be shown” may encompass, for example, a shorter duration of touch to button 202 necessary before display of notification object 350. “Being less likely to be shown” may refer to no display of notification object 350, and “being more likely to be shown” may refer to display of notification object 350.

(f3: Combination with Operation onto Controller 200)

When a gyro sensor is mounted on controller 200, the user can perform an input operation by tilting controller 200. Then, the operation onto controller 200 and touch to button 202 may be combined with each other.

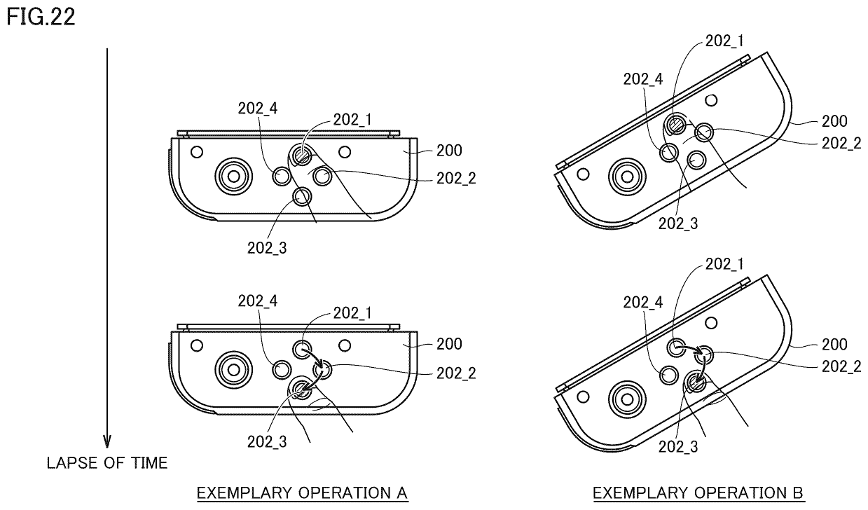

Exemplary combination between the operation onto controller 200 and the touch operation in the system according to the present embodiment will be described with reference to FIG. 22. As shown in an exemplary operation A, as the user successively touches a plurality of different buttons 202, predetermined processing is performed. As shown in an exemplary operation B, as the user tilts controller 200, different processing may be performed even when touch as in exemplary operation A is performed. Thus, even in the movement operation to sequentially touch at least two buttons 202 with the finger of the user, aspects of control to be carried out may be different depending on a state of controller 200 (for example, an angle of inclination or the like) or change in attitude (for example, an acceleration or the like).

A plurality of types of operability can be provided and hence usability can be enhanced by application of the operations by the user shown in exemplary operations A and B to an identical character object.

(f4: Combination with Operation onto Direction Indicator 208)

An operation onto direction indicator 208 of controller 200 and touch to button 202 may be combined with each other.

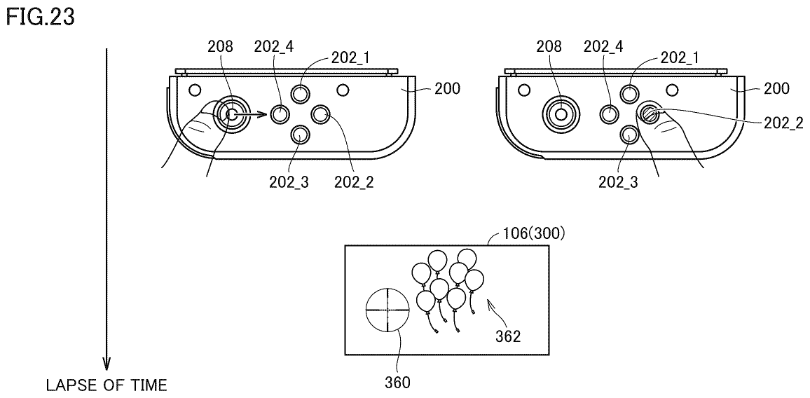

Exemplary combination between the operation onto direction indicator 208 of controller 200 and the touch operation in the system according to the present embodiment will be described with reference to FIG. 23. FIG. 23 shows exemplary game processing in which a balloon game object 362 is aimed at by a game object 360 representing the sight.

Adjustment of game object 360 is made by both of the operation onto direction indicator 208 and touch to button 202. Influence on game object 360 may be different for each operation.

For example, game object 360 moves to a larger extent in response to the operation onto direction indicator 208, and game object 360 moves to a smaller extent in response to touch (movement operation) to button 202. The user can roughly adjust the sight by operating direction indicator 208 and can finely adjust the sight by touching button 202.

A specific action may be performed on a direction of the sight by pressing of button 202 for fine adjustment. In contrast, game object 360 may move to a smaller extent in response to the operation onto direction indicator 208, and game object 360 may move to a larger extent in response to touch to button 202. At this time, a specific action may be performed on the direction of the sight by the operation onto direction indicator 208. A specific action may be performed on the direction of the sight by pressing of button 202.

In another exemplary operation, the direction in which the sight is directed (a direction of line of sight) may be adjusted in response to the operation onto direction indicator 208, and a position of a focus of the sight (a direction of depth) may be adjusted in response to touch to button 202.

By thus making manners of operations different while applying the operation onto direction indicator 108 of controller 200 and the touch operation onto button 202 to the identical game object, usability can be enhanced.

### (f5: Cyclic Touch Operation)

In the cursor movement processing described above, cursor 312 moves in response to successive touch to a plurality of buttons 202 clockwise or counterclockwise by the user. Game processing in which force or power is accumulated as a result of continued such cyclic touch operations may be adopted. The user proceeds with a game by continuing the cyclic touch operation until aimed force or power is accumulated.

Such a factor as how long the cyclic touch operation is to continue is applicable to any game processing.

### (f6: Electronic Book)

A page down function or a page up function of an electronic book may be performed by successive touch to a plurality of buttons clockwise or counterclockwise by the user, as in the cursor movement processing described above.

When a direction of movement of the finger of the user over button 202 can be detected, such an operation as zoom-in/-out and change of a range of display may be performed in accordance with the direction in which the finger of the user is moved over any button 202.

### (f7: Rhythm Game)

In the system according to the present embodiment, pressing of button 202 and touch to button 202 can be detected. Furthermore, based on the order of touch to button 202, upward and downward gesture input, left and right gesture input, diagonal gesture input, and rotational gesture input can also be detected. Furthermore, a direction in which the finger of the user moves over button 202 can also be detected.

By using such a large number of input operations, for example, a rhythm game improved in usability can be realized.

### (f8: Scroll Processing)

Though the example in which the cursor moves while display of the item in the game is maintained is shown in the cursor movement processing described above, the example may be applicable to scroll processing for changing a range of display on the screen. In this case, all or at least one of items shown on the screen may be moved in response to the operation by the user.

Though FIG. 7 described above shows, for example, nine items from an Item 1 to an Item 9, in the scroll processing, for example, items that follow the former which are an Item 10 and so on are shown.

With the scroll processing, cursor 312 may also move in coordination, or may be arranged at a predetermined position (for example, at the top of shown items) in the screen at each time point.

### G. Modification

The configurations in which processing is performed in response to the operation (movement operation) to sequentially touch (approach or contact) at least two buttons 202 with the finger of the user himself/herself are exemplified. In these exemplary configurations, main body apparatus 100 does not have to perform processing in response to the operation by the user simply in response to touch (approach or contact) to a single button 202 with the finger of the user alone, or it may perform predetermined processing when a specific condition is satisfied even when the finger of the user alone touches a single button 202.

Exemplary specific conditions may include a case where button 202 adjacent to one button 202 is not touched within a predetermined time period from movement from touch to one button 202 and a case where button 202 which is not an adjacent button is touched even when it is touched within the predetermined time period.

### H. Advantage

According to the present embodiment, since approach or contact of the finger of the user to a plurality of buttons 202 can be detected, system 1 can obtain not only information on the operation by the user to press button 202 but also information on the operation by the user such as approach or contact to button 202.

Since a plurality of pressable buttons 202 that are independent of each other are adopted, the user can indicate the function allocated to pressing of each button 202 and can distinguish between buttons 202 based on a tactile impression at the fingertip and then give an intended instruction to system 1 based on approach or contact to target button 202. Controller 200 improved in usability and processing in accordance with an operation given to controller 200 can thus be realized.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A system comprising:
a controller to be operated by a user; and
one or more processors, wherein
the controller comprises
a plurality of pressable buttons that are independent of each other,
a first sensor that detects pressing of at least one of the buttons, and
a second sensor that detects approach or contact of a finger of a user to at least one of the plurality of buttons, and
when a movement operation to sequentially approach or contact at least two buttons with the finger of the user is performed, the one or more processors perform first processing based on an order of the buttons approached or contacted in the movement operation.

2. The system according to claim 1, wherein
the one or more processors perform second processing based on pressing of a button of the plurality of buttons after the first processing is performed.

3. The system according to claim 2, wherein
the one or more processors perform the second processing whichever button of the plurality of buttons may be pressed.

4. The system according to claim 2, wherein
the one or more processors perform the second processing based on pressing of a button last in the movement operation while the finger of the user has approached or contacted the button.

5. The system according to claim 2, wherein
the one or more processors perform the second processing based on pressing of a button last approached or contacted in the movement operation before lapse of a predetermined time period since the finger of the user moved away from the button.

6. The system according to claim 1, wherein
the plurality of buttons comprise at least three buttons, and
the movement operation comprises the finger of the user sequentially approaching or contacting the at least three buttons.

7. The system according to claim 1, wherein
the one or more processors make processing aspects of the first processing different depending on whether the order of buttons approached or contacted in the movement operation is a clockwise order or a counterclockwise order.

8. The system according to claim 1, wherein
the first processing comprises processing for moving a cursor for selection of at least one of a plurality of shown items.

9. The system according to claim 1, wherein
the one or more processors perform the first processing based on pressing subsequent to the movement operation, of at least one of the plurality of buttons or a button different from the plurality of buttons.

10. The system according to claim 9, wherein
the one or more processors perform the first processing based on pressing subsequent to the movement operation, of a button last approached or contacted in the movement operation.

11. The system according to claim 9, wherein
the one or more processors perform the first processing based on pressing of a button last in the movement operation while the finger of the user has approached or contacted the button.

12. The system according to claim 9, wherein
the one or more processors perform the first processing based on pressing of a button last approached or contacted in the movement operation before lapse of a predetermined time period since the finger of the user moved away from the button.

13. The system according to claim 1, wherein
the one or more processors do not perform processing in accordance with an operation by the user simply in response to approach or contact of the finger of the user alone to one of the buttons.

14. The system according to claim 1, wherein
the controller is configured to be held by the user, and
the plurality of buttons are provided in a first area where the plurality of buttons are operable with one finger of the user who holds the controller.

15. The system according to claim 14, wherein
a plurality of pressable buttons that are independent of each other are provided in a second area different from the first area, and
the plurality of buttons provided in the first area and the plurality of buttons provided in the second area are configured to independently detect the movement operation onto the plurality of buttons.

16. The system according to claim 1, wherein
the plurality of buttons comprise four buttons, and
the four buttons are annularly arranged.

17. The system according to claim 16, wherein
when the movement operation is such that the finger of the user moves from a first button among the four buttons to approach or contact a second button different from a third button and a fourth button adjacent to the first button, the one or more processors perform the first processing based on approach or contact of the finger of the user to the third button and the fourth button among the four buttons.

18. The system according to claim 17, wherein
the one or more processors perform the first processing based on approach or contact of the finger of the user to both of the third button and the fourth button.

19. The system according to claim 17, wherein
the one or more processors perform identical first processing in both of a case where the finger of the user approaches or contacts one of the third button and the fourth button and a case where the finger of the user approaches or contacts both of the third button and the fourth button.

20. The system according to claim 1, wherein
the one or more processors perform processing and output an image generated by the performed processing, and
the first processing comprises processing for changing an outputted image.

21. An information processing apparatus connected to a controller to be operated by a user, the controller comprising a plurality of pressable buttons that are independent of each other, a first sensor that detects pressing of at least one of the buttons, and a second sensor that detects approach or contact of a finger of a user to at least one of the plurality of buttons, the information processing apparatus comprising:
one or more processors, wherein
when such a movement operation that the finger of the user sequentially approaches or contacts at least two buttons is performed, the one or more processors perform first processing based on an order of the buttons approached or contacted in the movement operation.

22. An information processing method performed in a system comprising a controller to be operated by a user, the controller comprising a plurality of pressable buttons that are independent of each other, a first sensor that detects pressing of at least one of the buttons, and a second sensor that detects approach or contact of a finger of a user to at least one of the plurality of buttons, the information processing method comprising:
accepting an operation by the user onto the controller; and
performing, when such a movement operation that the finger of the user sequentially approaches or contacts at least two buttons is performed, first processing based on an order of the buttons approached or contacted in the movement operation.

23. A non-transitory computer-readable storage medium having instructions stored thereon which, when executed, cause one or more processors of a device connected to a controller to be operated by a user to perform operations, the controller comprising a plurality of pressable buttons that are independent of each other, a first sensor that detects pressing of at least one of the buttons, and a second sensor that detects approach or contact of a finger of a user to at least one of the plurality of buttons, the operations comprising:
accepting an operation by the user onto the controller; and
performing, when such a movement operation that the finger of the user sequentially approaches or contacts at least two buttons is performed, first processing based on an order of the buttons approached or contacted in the movement operation.
